(19) United States
(12) Patent Application Publication
(10) Pub. No.: US 2021/0207871 A1
(43) Pub. Date: Jul. 8, 2021

(54) ENTRANCE REFRIGERATOR AND STORAGE SYSTEM FOR HOUSE ENTRANCE HAVING THE SAME

(71) Applicant: LG ELECTRONICS INC., Seoul (KR)

(72) Inventors: Boan KWON, Seoul (KR); Minkyu OH, Seoul (KR); Daewoong KIM, Seoul (KR); In Sun YEO, Seoul (KR)

(73) Assignee: LG ELECTRONICS INC., Seoul (KR)

(21) Appl. No.: 16/886,528

(22) Filed: May 28, 2020

(30) Foreign Application Priority Data
Jan. 2, 2020 (KR) 10-2020-0000089

(51) Int. Cl. F25D 13/04; F25D 17/06; F25D 23/02; F25D 23/10

(52) U.S. Cl. CPC F25D 13/04; F25D 17/065; F25D 17/067; F25D 2323/02; F25D 23/10; F25D 2300/00; F25D 23/028

(57) ABSTRACT

A storage chamber for a house entrance includes an entrance refrigerator, a first storage disposed adjacent to the entrance refrigerator, and a cold air supply assembly including a heat absorption part and a heat dissipation part to supply cold air to a storage space of the entrance refrigerator, wherein the heat dissipation part of the cold air supply assembly is disposed in the first storage.

### CROSS-REFERENCE TO RELATED APPLICATIONS

This application claims the priority benefit of the Korean Patent Application No. 10-2020-0000089 filed in the Republic of Korea on Jan. 2, 2020, which is hereby incorporated by reference as if fully set forth herein.

### BACKGROUND

### Field of the Invention

The present disclosure relates to an entrance refrigerator and a storage system for a house entrance having the same.

### Discussion of the Related Art

Recently, delivery services for delivering articles (or goods) to a certain place has been commonplace. In particular, when the article to be delivered is fresh food, the fresh food may be stored and delivered in a refrigerator or in a warmer, the refrigerator or warmer may be provided in a delivery vehicle, in order to prevent the food from being spoiled or cooled.

Food is generally delivered in a packing material to maintain a cooling or warming state. The packing material is formed of environmental pollutants, such as Styrofoam® or an extruded polystyrene foam or other insulating material. There is an increasing need to reduce the environmental pollutants, including socially and economically.

Additionally, if a user is at home at a delivery time, the user may directly receive food from a courier (i.e., a delivery person) face to face, but if the user is not at home, such as when the delivery time is too early or late, it may be difficult for the user to directly receive food from the courier face to face.

Therefore, there is a need for food to be received even if the user does not come into direct contact with a courier and there is a need for food not to be spoiled or to be overly cooled until the food is finally delivered to the user. That is, there is a need to maintain the food in the manner in which it was delivered, including the temperature it was delivered, in order to preserve its freshness or to keep the food at a desired temperature for consumption.

In order to solve these above problems, recently, a product, such as a refrigerator, is installed at an entrance (e.g., front door) of a user's residence or other place, so that the courier may store the delivered food in the refrigerator to keep the food fresh and the user may access the refrigerator at a convenient time to receive the food.

A related art below discloses an entrance refrigerator provided to be mounted on an entrance door or embedded (e.g., provided) in a wall that borders an entrance hallway.

Related art: Korean Utility Model Registration No. 20-0357547, dated Jul. 19, 2004.

### SUMMARY

An aspect of the present disclosure is directed to providing an entrance refrigerator employing a refrigerating cycle to supply cold air, and a storage system for a house entrance having the same.

To achieve these and other advantages and in accordance with the purpose of the disclosure, as embodied and broadly described herein, there is provided a storage system for a house entrance, including an entrance refrigerator, a first storage disposed adjacent to the entrance refrigerator, and a cold air supply module (e.g., assembly, unit) including a heat absorption part and a heat dissipation part to supply cold air to a storage space of the entrance refrigerator, wherein the heat dissipation part of the cold air supply module is disposed in the first storage.

The heat dissipation part may include a compressor, a condenser, and a condenser fan, and the heat absorption part may be disposed in the entrance refrigerator.

A storage system for a house entrance according to another embodiment of the present disclosure is the same as the storage system for a house entrance according to the former embodiment, except that the heat dissipation part is mounted on a rear surface of the entrance refrigerator.

According to the entrance refrigerator and the storage system for a house entrance of the embodiment of the present disclosure, a freezing function, as well as a refrigerating function, may be selectively implemented. Therefore, a storage compartment may be controlled in any one storage mode of freezing storage and refrigerating storage according to storage conditions of the goods to be delivered.

In addition, since a mechanical room for accommodating the compressor, the condenser, and the condenser fan is disposed in another storage compartment adjacent to the entrance refrigerator, a storage space of the entrance refrigerator may be sufficiently enhanced.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a front perspective view of a storage system for a house entrance according to an embodiment of the present disclosure.

FIG. 2 is a perspective view showing an inside of a (house) entrance taken along line 2-2 of FIG. 1.

FIG. 3 is a front perspective view of an entrance refrigerator of a storage system for a house entrance according to an embodiment of the present disclosure.

FIG. 4 is a front perspective view of an entrance refrigerator in a state in which an inner door and an outer door are removed according to an embodiment of the present disclosure.

FIG. 5 is a rear perspective view of an entrance refrigerator in a state in which an inner door and an outer door are removed according to an embodiment of the present disclosure.

FIG. 6 is an exploded perspective view of an entrance refrigerator according to an embodiment of the present disclosure.

FIG. 7 is a cross-sectional view, taken along line 7-7 of FIG. 4.

FIG. 8 is a longitudinal cross-sectional view, taken along line 8-8 of FIG. 4.

FIG. 9 is a perspective view of a cold air supply module provided in an entrance refrigerator according to an embodiment of the present disclosure.

FIG. 10 is a front perspective view of an inner case of a cabinet of an entrance refrigerator according to an embodiment of the present disclosure.

FIG. 11 is a rear perspective view of the inner case.

FIG. 12 is a rear perspective view of a guide plate of an entrance refrigerator according to an embodiment of the present disclosure.

FIG. 13 is a front perspective view of a housing according to an embodiment of the present disclosure.

FIG. 14 is a view showing air circulation that occurs at a rear of an entrance refrigerator according to an embodiment of the present disclosure.

FIG. 15 is a side cross-sectional view of a storage system for a house entrance according to another embodiment of the present disclosure.

### DETAILED DESCRIPTION OF THE DISCLOSURE

Hereinafter, an entrance refrigerator and a storage system for a house entrance having the same according to embodiments of the present disclosure will be described in detail with reference to the accompanying drawings.

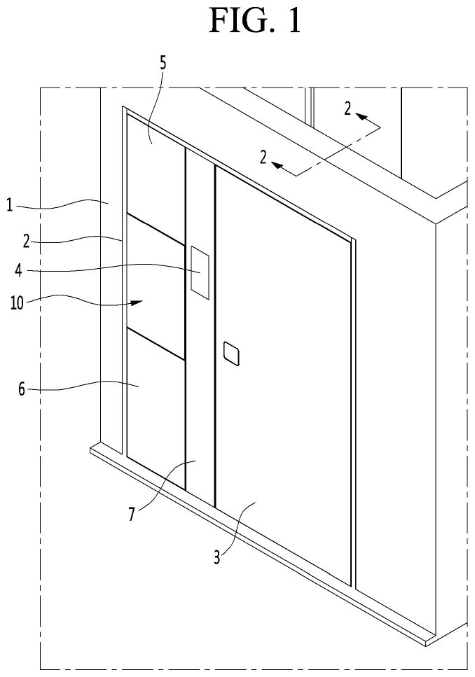

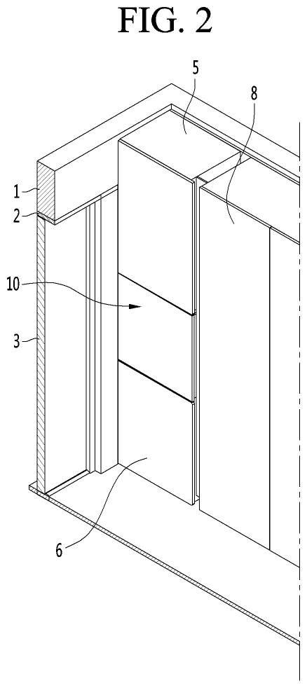

FIG. 1 is a front perspective view of a storage system for a house entrance according to an embodiment of the present disclosure, and FIG. 2 is a perspective view showing an inside of an entrance taken along line 2-2 of FIG. 1.

Referring to FIGS. 1 and 2, an opening is formed on an outer wall 1 partitioning an indoor area and a corridor, and a frame 2 is provided at the edge of the opening. That is, the frame 2 is attached to the opening of the outer wall 1. In addition, an entrance door 3 may be installed inside the frame 2, and an entrance refrigerator 10 may be disposed on a side of the entrance door 3 (e.g., the entrance refrigerator 10 may be positioned within the frame and adjacent to the entrance door 3).

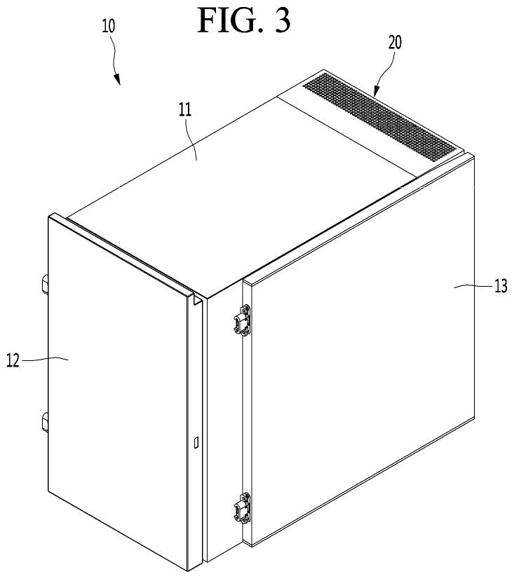

A partition or a partition wall 7 may be formed between the entrance door 3 and the entrance refrigerator 10, and the partition 7 opens and closes the entrance door 3, which may be a front door. The partition 7 may have a control panel 4 for controlling opening and closing of the entrance door 3 and opening and closing of a door 12 (see FIG. 3) of the entrance refrigerator 10.

The control panel 4 may include at least one of a face recognition sensor for recognizing a face of an approaching person, a code reader for recognizing an encryption code of a delivery service article to be stored in the entrance refrigerator 10, a proximity sensor, a controller (e.g., processor, CPU) and a display unit. Further, the at least one face recognition sensor, the code reader, and the proximity sensor of the code reader 4 may be installed at one side or multiple sides of the control panel 4. A face image of an approaching person, recognized by the face recognition sensor, may be displayed on the display unit of the control panel 4.

In addition, a controller of the control panel 4 may perform a function of controlling opening and closing of an outdoor side door and an indoor side door of the entrance refrigerator 10, as well as a function of controlling opening and closing of the entrance door 3, according to a result of the face recognition.

For example, the controller of the control panel 4 may perform a function of opening an outdoor side door of the entrance refrigerator 10 according to a result of recognizing a delivery article and automatically perform a function of locking the outdoor side door when the outdoor side door is recognized to be closed.

In addition, in a state where one of the outdoor side door and an indoor side door of the entrance refrigerator 10 is open, the controller of the control panel 4 may maintain the other in a closed state.

Alternatively, an independent control panel may be provided for performing the functions on the indoor side door of the entrance refrigerator or the outdoor side door of the entrance refrigerator 10 described above with respect to the control panel 4.

Additionally, an upper side (e.g., upper portion) of the entrance refrigerator 10 may be provided with a first storage 5, and a lower side (e.g., lower portion) thereof, below the first storage 5, may be provided with a second storage 6. The first storage 5 may function as a warmer for storing articles in a warmed state. In addition, the second storage 6 may be maintained at room temperature to simply perform a function of storing a delivery service article (e.g., an article not needing to be maintained a particular temperature) or may be maintained at a temperature different from an internal temperature of the entrance refrigerator 10. Alternatively, the second storage may be maintained at a temperature lower than room temperature.

The first storage 5 may be maintained at a refrigerating temperature or freezing temperature, and the second storage 6 may be used as a space maintained at room temperature so as to perform only a function of storing a delivery service article.

Additionally, one or a plurality of third storages 8 may be installed on an indoor entrance side wall corresponding to a rear of the entrance refrigerator 10. The third storage 8 may be adjacent to the first storage 5 and the second storage 6, including between the first storage 5 and the entrance door 3 and between the second storage 6 and the entrance door 3. The third storage 8 may be used as a space for storing shoes, umbrellas, or laundry.

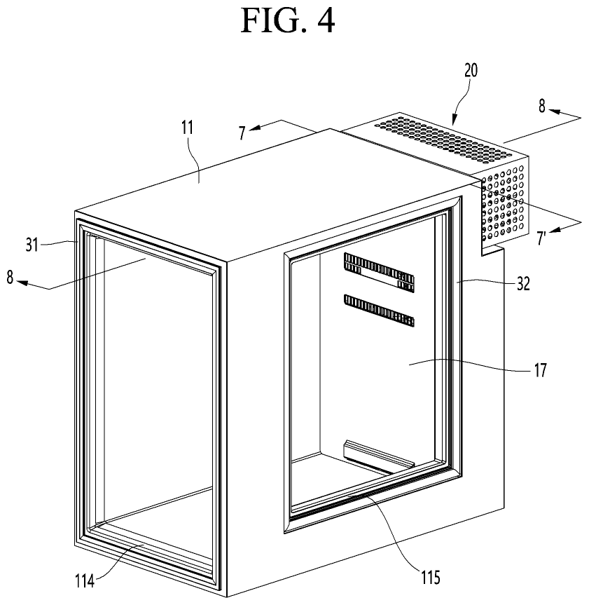

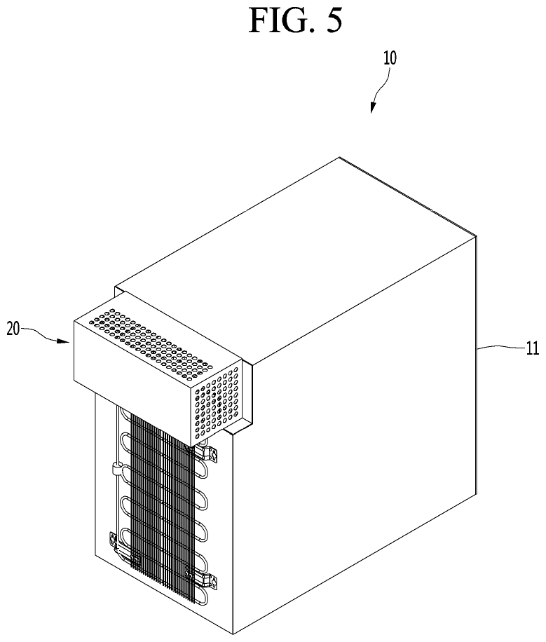

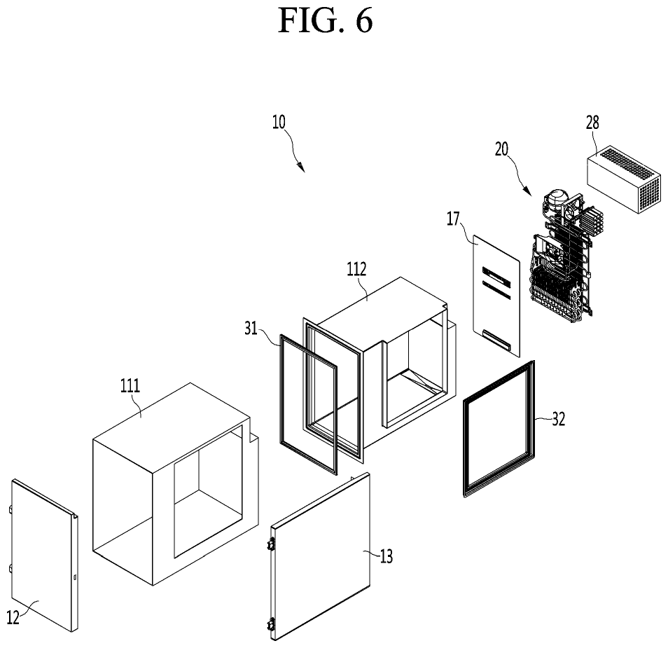

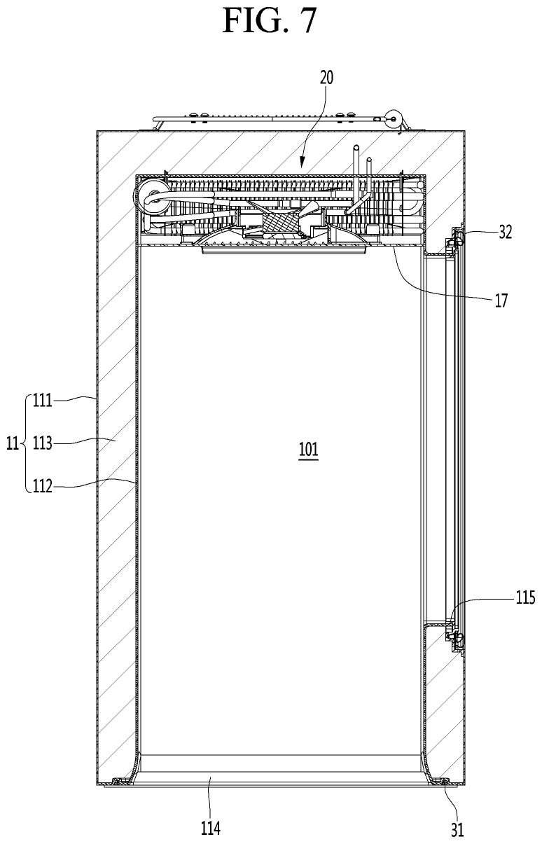

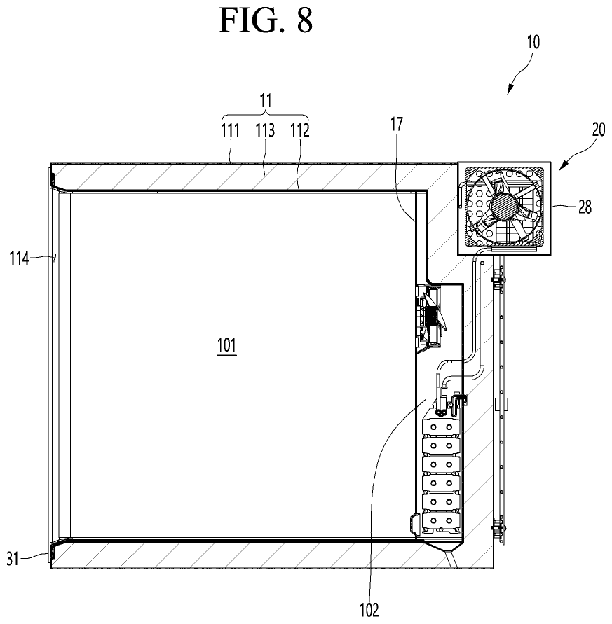

FIG. 3 is a front perspective view of an entrance refrigerator of a storage system for a house entrance according to an embodiment of the present disclosure, FIG. 4 is a front perspective view of an entrance refrigerator in a state in which an inner door and an outer door are removed according to an embodiment of the present disclosure, FIG. 5 is a rear perspective view of an entrance refrigerator in a state in which an inner door and an outer door are removed according to an embodiment of the present disclosure, FIG. 6 is an exploded perspective view of an entrance refrigerator according to an embodiment of the present disclosure, FIG. 7 is a cross-sectional view, taken along line 7-7 of FIG. 4, and FIG. 8 is a longitudinal cross-sectional view, taken along line 8-8 of FIG. 4.

Referring to FIGS. 3 to 8, the entrance refrigerator 10 according to an embodiment of the present disclosure may be understood as a wall-mounted refrigerator in which a front portion penetrates an outer wall 1.

Specifically, the entrance refrigerator 10 may include a cabinet 11 partially embedded in an outer wall 1 (e.g., an entrance/front wall of a dwelling/building), an outer door 12 for opening and closing an outer opening 114 provided at a front end of the cabinet 11, an inner door 13 for opening and closing an inner opening 115 provided on a side surface of the cabinet 11, and one or a plurality of cold air supply modules (e.g., assemblies) 20 mounted on a rear surface of the cabinet 11.

Here, the outer opening 114 may be provided on a front surface of the cabinet 11 and may be defined as a front opening, and the inner opening 115 may be provided on the side surface of the cabinet 11, adjacent to the outer opening 114, and may be defined as a side opening. Alternatively, one of the outer opening 114 and the inner opening 115 may be defined as a first opening and the other may be defined as a second opening. One of the outer door 12 and the inner door 13 may be defined as a first door and the other may be defined as a second door.

In addition, a range in which the entrance refrigerator 10 is mounted on the outer wall 1 partitioning the indoor area and outdoor area may include the entrance refrigerator 10 being attached (e.g., embedded, connected) to a wall that partitions multiple indoor spaces, including a first indoor space and a second indoor space, or a wall that partitions an indoor area and an outer corridor.

For example, the range may also include a case where the entrance refrigerator 10 is attached/embedded in a wall formed between an entrance door and a middle door that separates the entrance and a room of a home, such as a kitchen. In this case, when an article is input in the entrance, the article may be taken out in the kitchen on the other side.

In addition, the entrance refrigerator 10 may further include a cold air supply module 20 mounted on a rear surface of the cabinet 11 and a housing 28 configured to receive (e.g., enclose) some components of the cold air supply module 20. It should be appreciated that the cold air supply module 20 may be defined as including the housing 28.

In addition, the entrance refrigerator 10 may further include an inner gasket 31 and an outer gasket 32 (see FIG. 4). Specifically, the inner gasket 31 is mounted on a front surface of the cabinet 11 corresponding to an edge of the outer opening 114. The outer gasket 32 is mounted on a side surface of the cabinet 11 corresponding to an edge of the inner opening 115.

In addition, the entrance refrigerator 10 may further include a guide plate 17 (e.g., a partition plate) partitioning an internal space of the cabinet 11 into a storage compartment 101 and a cold air generating compartment 102.

Additionally, the cabinet 11 may include an outer case 111 forming an appearance, an inner case 112 provided inside the outer case 111, and a thermal insulator 113 filled between the outer case 111 and the inner case 112. The storage compartment 101 and the cold air generating compartment 102 may be provided inside the inner case 112.

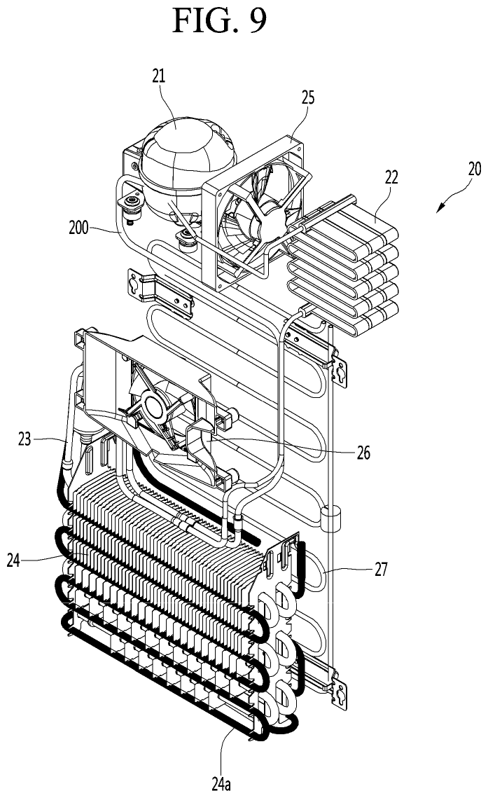

FIG. 9 is a perspective view of a cold air supply module provided in an entrance refrigerator according to an embodiment of the present disclosure.

Referring to FIG. 9, the cold air supply module 20 may include a compressor 21, a condenser 22, 27, a capillary tube 23 (e.g. expansion device), an evaporator 24, a condenser fan 25, an evaporator fan 26, and a refrigerant pipe 200 connecting these components to form a single refrigerant circuit.

In addition, the evaporator 24 may be equipped with a defrost heater 24a, and the defrost heater 24a may operate in a defrost mode for removing frost formed on a surface of the evaporator 24.

The defrost heater 24a may be disposed only at a lower region of the evaporator 24 or may be evenly (e.g., uniformly) installed (e.g., positioned) over front and rear surfaces of the evaporator 24 as illustrated.

Specifically, the condenser may include a main condenser 22 and an auxiliary condenser 27 but it is not excluded that a single condenser is applied according to a design cooling capacity of the entrance refrigerator 10.

The condenser may be connected to an outlet side of the compressor 21, and the main condenser 22 and the auxiliary condenser 27 may be connected in series.

Alternatively, the main condenser 22 and the auxiliary condenser 27 may be connected in parallel, and a switching valve may be installed (e.g., positioned) on the refrigerant pipe 200 at a point where the refrigerant pipe is branched toward the main condenser 22 and the auxiliary condenser 27. That is, the switching valve may be positioned on the refrigerant pipe 200 between the main condenser 22 and the auxiliary condenser 27, or any point on the refrigerant pipe 200 to switch between the main condenser 22, the auxiliary condenser 27 and both the main condenser 22 and the auxiliary condenser 27.

According to this structure, only the main condenser 22 may be used or both the main condenser 22 and the auxiliary condenser 27 may be used by adjusting an opening degree of the switching valve depending on required cooling power of the entrance refrigerator 10. Alternatively, both the main condenser 22 and the auxiliary condenser 27 may be used, and here, the amount of a refrigerant moving toward the auxiliary condenser 27 may vary according to an opening degree of the switching valve.

However, it should be appreciated that a structure in which the main condenser 22 and the auxiliary condenser 27 are connected in series may also be implemented.

In addition, the capillary tube 23 is connected to an outlet of the condenser, and the evaporator 24 is connected to an outlet of the capillary tube 23. The refrigerant pipe 200 extending from an outlet of the evaporator 24 is connected to an inlet of the compressor 21.

In addition, the compressor 21, the main condenser 22, and the condenser fan 25 may be accommodated (e.g., positioned) in the housing 28. The condenser fan 25 may be disposed between the compressor 21 and the main condenser 22.

In addition, the auxiliary condenser 27 may be fixed to (e.g., mounted on, positioned on) a rear surface of the cabinet 11, specifically, a rear surface of the outer case 111. When the auxiliary condenser 27 is fixed to the rear surface of the cabinet 11, the auxiliary condenser 27 is exposed to external air.

In addition, the capillary tube 23 is a unit for lowering temperature and pressure by expanding the refrigerant passing through the condenser, and an expansion valve may be utilized instead of the capillary tube 23. The capillary tube 23 may be defined as an example of an expansion member.

The capillary tube 23 and the evaporator 24 may be disposed in the cold air generating compartment 102, and the evaporator fan 26 may be disposed above the evaporator 24 (e.g., spaced apart from the evaporator 24 in a vertical direction).

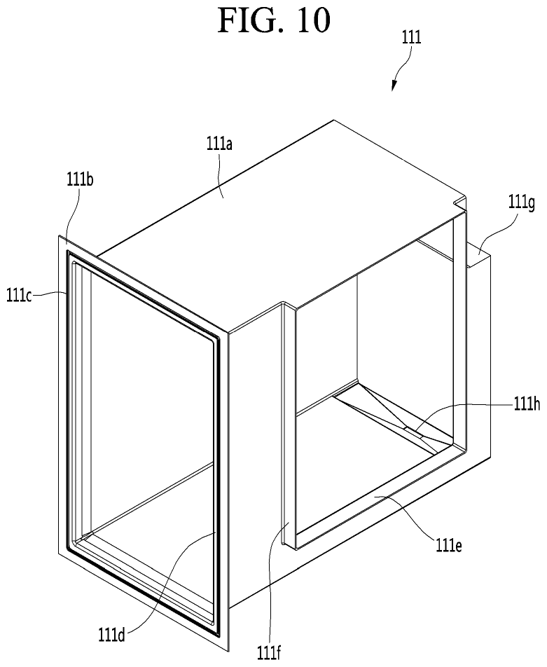

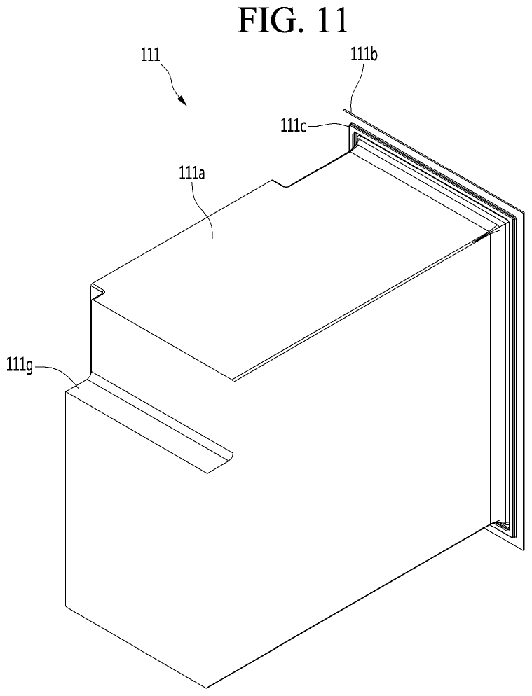

FIG. 10 is a front perspective view of an inner case configuring a cabinet of an entrance refrigerator according to an embodiment of the present disclosure, and FIG. 11 is a rear perspective view of the inner case.

Referring to FIGS. 10 and 11, the outer case 111 configuring the cabinet 11 of the entrance refrigerator 10 according to an embodiment of the present disclosure may have a hexahedral shape, or may have any other shape.

The outer case 111 may include a case body 111a in which a front surface and a portion of a side surface are open, a flange 111b extending vertically from a front end of the case body 111a, a sleeve (e.g., flange) 111f protruding by a predetermined length from one side surface of the case body 111a, and a housing seating portion 111g defined on a rear surface of the case body 111a.

An outer opening 111d is formed at an inner edge of the flange 111b, and an inner opening 111e is defined by the sleeve 111f. The sleeve 111f protrudes by a predetermined length from the side surface of the case body 111a and is enclosed in a quadrangular band shape to form the inner opening 111e on an inner side thereof. That is, the sleeve 111f may include a left sleeve, a right sleeve, an upper sleeve, and a lower sleeve, and the upper sleeve is coplanar with an upper surface of the case body 111a. The left and right sleeves and the lower sleeve are all perpendicular to the side surface of the case body 111a.

In addition, a gasket groove 111c is recessed on a front surface of the flange 111b, and a fastening portion of the inner gasket 31 is inserted into the gasket groove 111c.

In addition, the flange 111b may be formed by a portion of the case body 111a (e.g., bending a portion of the case body 111a) or the flange 111b may be formed by a separate member (e.g., component, element) that is coupled to the front end of the case body 111a.

In addition, the sleeve 111f may be formed by bending and extending a portion of the side surface of the case body 111a or it should be appreciated that the sleeve 111f may be coupled in a separate flange form to the inner opening 111e.

In addition, a drain hole 111h may be formed on an inner bottom surface of the outer case 111, including an inner bottom surface of the inner case adjacent to a rear surface of the cabinet 11.

Specifically, the inner bottom surface of the outer case 111 may be partitioned into a storage compartment bottom surface and a cold air generating compartment bottom surface by the guide plate 17, and the drain hole 111h may be formed on one side of the cold air generating compartment bottom surface. The drain hole 111h may be formed at the center of the bottom surface of the cold air generating compartment but is not limited thereto.

In addition, as illustrated, the bottom surface of the cold air generating compartment 102 may be designed to be lowered toward the drain hole 111h. That is, the cold air generating compartment 102 may have a bottom surface that is sloped toward the drain hole 111h, such that condensate water or defrost water falling from the evaporator 24 to the bottom surface of the cold air generating compartment flows toward the drain hole 111h.

Additionally, the housing seating portion 111g may be formed on an upper rear side of the outer case 111. Specifically, the housing seating portion 111g may be formed in a shape in which a rear end of the upper surface of the case body 111a is stepped by a predetermined depth. A height of the housing seating portion 111g may be formed to have a length corresponding to a height of the housing 28, and a width of the housing seating portion 111g in a front-rear direction may be designed to be smaller than a width of a bottom portion of the housing 28 in the front-rear direction.

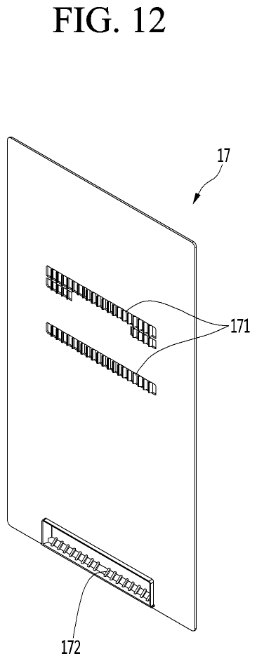

FIG. 12 is a rear perspective view of a guide plate 17 of an entrance refrigerator according to an embodiment of the present disclosure.

Referring to FIG. 12, as described above, the guide plate 17 according to an embodiment of the present disclosure, functions to partition the internal space of the cabinet 11 into a storage compartment 101 and the cold air generating compartment 102. Thus, the guide plate 17 may be defined as a partition plate.

Specifically, a discharge grille 171 may be formed at a point spaced apart by a predetermined distance downward from an upper end of the guide plate 17, and an intake grille 172 may be formed at a lower end of the guide plate 17.

The evaporator fan 26 is coupled to a rear surface of the guide plate 17 corresponding to a position of the discharge grille 171 so that cold air inside the cold air generating compartment 102 may be supplied to the storage compartment 101. That is, the evaporator fan 26 may overlap the discharge grille 171 in a rear direction (e.g., horizontal direction).

In addition, cold air in the storage compartment 101 is returned to the cold air generating compartment 102 through the intake grille 172. Since the discharge grille 171 is formed above the intake grille 172, when the evaporator fan 26 is driven, cold air of the cold air generating compartment 102 is supplied to the storage compartment 101 and then falls to the bottom of the storage compartment. The cold air present on the bottom of the storage compartment 101 is returned to the cold air generating compartment 102 through the intake grille 172. The cold air returned to the cold air generating compartment 102 rises by a pressure difference between an upper space and a lower space of the cold air generating compartment to exchange heat with the evaporator 24.

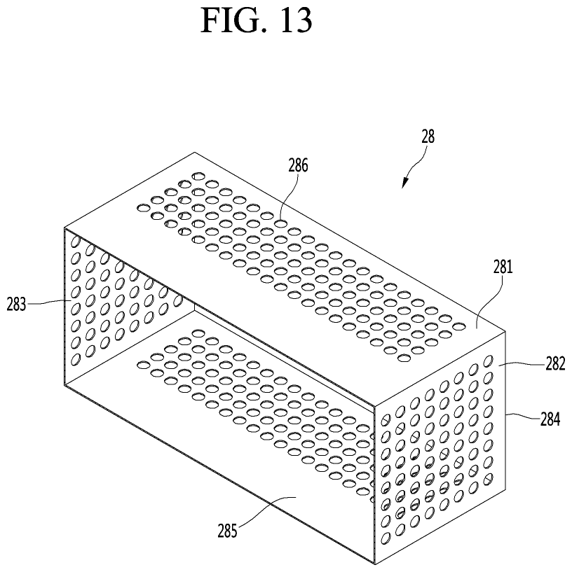

FIG. 13 is a front perspective view of a housing according to an embodiment of the present disclosure.

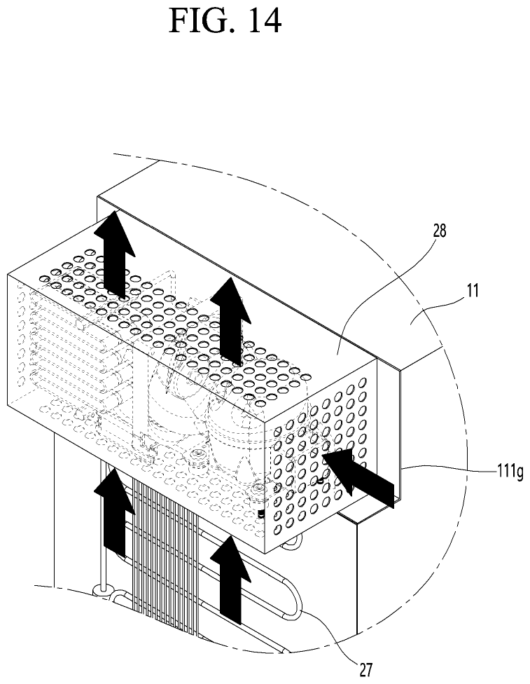

Referring to FIG. 13, the housing 28 according to an embodiment of the present disclosure is placed in the housing seating portion 111g (see FIG. 14) formed on the rear surface of the cabinet 11.

Specifically, the housing seating portion 111g may be formed at a step of the upper end of the rear surface of the cabinet 11, the step extending a predetermined depth. A length of the housing seating portion 111g in the front-rear direction (e.g., horizontal direction) may be smaller than a length of the housing 28 in the front-rear direction, but without being limited thereto, or the length of the housing seating portion 111g in the front-rear direction may be formed to be equal to or greater than the length of the housing 28 in the front-rear direction.

That is, the housing 28 may protrude backward from the rear surface of the cabinet 11 (e.g., the housing 28 may extend past the rear surface of the cabinet 11), so that the rear surface of the housing 28 may be located on a rear side with respect to the rear surface of the cabinet 11.

The housing 28 may be formed in a hexahedral form including a front surface portion, a left surface portion 283, a right surface portion 282, an upper surface portion 281, a rear surface portion 284, and a bottom surface portion 285. Here, the front surface portion may be open or closed. When the front surface portion is open, a front end of the housing 28 may be in close contact with a vertical plane of the housing seating portion 111g. Conversely, if the front surface portion is sealed, the front surface portion of the housing 28 may be in close contact with the vertical plane of the housing seating portion 111g.

When the length of the housing 28 in the front-rear direction is formed larger than the length of the housing seating portion 111g in the front-rear direction, only a part of the bottom portion 285 is placed on a horizontal portion (or a bottom portion) of the housing seating portion 111g.

In addition, a plurality of heat dissipation holes 286 may be formed on each surface of the housing 28 except for the front surface portion and the rear surface portion 284.

Specifically, the plurality of heat dissipation holes 286 may be formed from a point spaced apart by a predetermined distance backward from a front end of the housing 28 on the upper surface portion 281 and the bottom surface portion 285. A region of the bottom surface portion in which the heat dissipation holes 286 are not formed may be a region in which the housing 28 is in close contact with a bottom portion of the housing seating portion 111g.

The heat dissipation holes 286 formed in the upper surface portion 281 are also formed from a point spaced apart backward from the front end like the bottom surface portion 285, and thus, there is no need to distinguish between the upper surface portion 281 and the bottom surface portion 285 of the housing 28. If the heat dissipation holes 286 are formed in the entire upper surface portion 281, the bottom surface portion 285 of the housing 28 is designated, and thus, attention may be required in coupling the housing 28 to the housing seating portion 111g.

Additionally, the heat dissipation holes 286 may be formed in the entirety of the side surface portions 282 and 283 and the rear surface portion 284.

FIG. 14 is a view showing air circulation that occurs at a rear of an entrance refrigerator according to an embodiment of the present disclosure.

Referring to FIG. 14, the compressor 21 and the condenser, specifically, the main condenser 22, are accommodated in the housing 28, and the auxiliary condenser 27 is mounted on the rear surface of the cabinet 11 to exchange heat with indoor air.

Specifically, when a refrigerating cycle operates, the compressor 21 is driven. The compressor 21 compresses a gaseous refrigerant having a low temperature and low pressure into a gaseous refrigerant having a high temperature and high pressure. Therefore, an internal temperature of the compressor 21 is higher than an external temperature of the housing 28.

In addition, the high-temperature, high-pressure gaseous refrigerant passing through the compressor 21 is changed in phase into a liquid refrigerant having a high temperature and high pressure, while passing through the condensers 22 and 27. In this process, a large amount of heat is released to the outside from the condensers 22 and 27. Efficiency of the refrigerating cycle is increased when air outside the condensers 22 and 27 and the housing 28 are rapidly heat exchanged so that the gaseous refrigerant is entirely changed into the refrigerant in the liquid state.

Therefore, when the condenser fan 25 is driven, the air outside the housing 28 should be introduced into the housing 28, and this is more advantageous as flow resistance is smaller in the inflow process. For this reason, the plurality of heat dissipation holes 286 are formed on the surface of the housing 28.

Specifically, when the condenser fan 25 is driven, the indoor air outside the housing 28 flows into the housing 28 through the bottom surface portion 285 and the right surface portion 284 of the housing 28. The indoor air introduced into the housing 28 cools the compressor 21, while passing over the compressor 21.

A portion of the indoor air which has cooled the compressor 21 is discharged back to the room through the upper surface portion 281 of the housing 28, and the other remaining portion thereof flows toward the main condenser 22 through the condenser fan 25.

The indoor air flowing toward the main condenser 22 cools the main condenser 22, and then is discharged in a state of having an increased temperature to the room through the upper surface portion 281 of the housing 28.

Here, the indoor air may immediately flow toward the main condenser 22 through the bottom surface portion 285 of the housing 28 due to a pressure difference generated inside the housing 28 in which the main condenser 22 is placed.

As air having a lower density by absorbing heat emitted from the main condenser 22 is discharged to the outside of the housing 28, the pressure inside the housing 28 may be lower than a pressure outside the housing. In this situation, indoor air outside the housing 28 may be introduced into the housing 28 through heat dissipation holes 286 formed in the bottom surface portion 285.

Additionally, since the auxiliary condenser 27 is exposed to the indoor air, the auxiliary condenser 27 may always exchange heat with indoor air, regardless of whether the condenser fan 25 is driven. However, when the condenser fan 25 is driven, forced air flow occurs at the rear region of the cabinet 11, increasing the amount of heat exchange between indoor air and the auxiliary condenser 27.

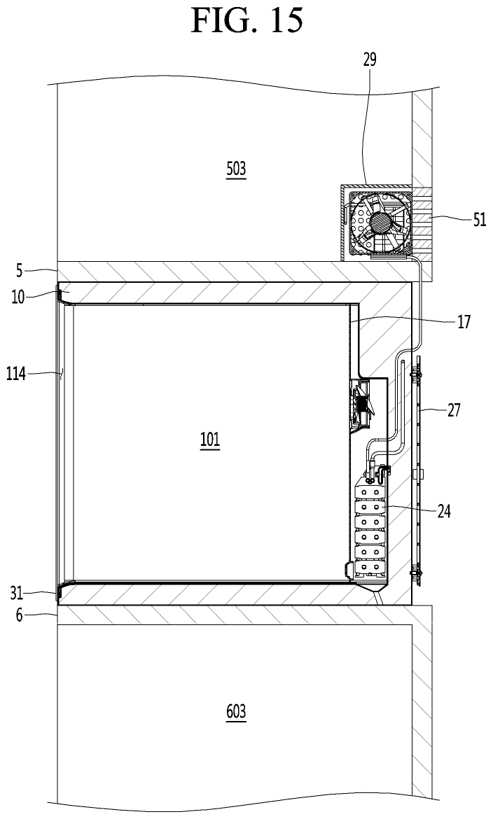

FIG. 15 is a side cross-sectional view of a storage system for a house entrance according to another embodiment of the present disclosure.

Referring to FIG. 15, the cold air supply module 20 provided at the entrance refrigerator 10 according to an embodiment of the present disclosure may be divided into a heat absorption part and a heat dissipation part.

Specifically, the heat absorption part may include the evaporator 24, the evaporator fan 26, and the capillary tube 23 (e.g. expansion member), and the heat dissipation part may include the compressor 21, the condenser 22, and the condenser fan 25.

In addition, the heat dissipation part of the cold air supply module 20 may be disposed at another storage compartment disposed adjacent to the entrance refrigerator 10, rather than being provided on one side of the cabinet 11 of the entrance refrigerator 10.

That is, the heat dissipation part may be disposed at a rear of the first storage compartment 503 of the first storage 5 disposed above the cabinet 11 or at a rear of the second storage 6 disposed below the cabinet 11. In the present embodiment, a case where the heat dissipation part is accommodated at the rear of the first storage compartment 503 will be described as an example.

A machine room cover 29 may be provided at a rear lower end of the first storage compartment 503, and a space accommodating the heat dissipation part may be formed by the machine room cover 29. A space formed by the machine room cover 29 and a rear wall and a bottom of the first storage 5 may be defined as a machine room. The machine room accommodates components of the heat dissipation part, i.e., at least the compressor 21, the condenser 22, and the condenser fan 25.

In addition, a portion of the rear wall of the first storage 5 defining a rear surface of the machine room may be cut away and a back cover 51 may be mounted on the cut portion. A plurality of holes may be formed in the back cover 51 to allow external air to flow into the machine room or air inside the machine room to be discharged to the outside. That is, the back cover 51 may be positioned directly adjacent (e.g., abutting) the machine room to allow air to flow in and out of the machine room.

The machine room cover 29 may separate the first storage compartment 503 and the machine room so that heat inside the machine room may not be introduced into the first storage compartment 503.

If the first storage compartment 503 is used as a storage compartment for warming storage, a communication hole that may be opened and closed may be formed in the machine compartment cover 29 so that heat inside the machine room is introduced into the first storage compartment 503. That is, when the condenser fan 25 operates, the air inside the machine room and the air inside the first storage compartment 503 circulate. This structure may be understood as a structure in which the housing 28 described in the former embodiment is disposed in the first storage compartment 503.

In addition, the refrigerant pipe 200 connected to the compressor 21 and the condenser 22 extends toward the cabinet 11 of the entrance refrigerator 10 through the bottom of the first storage 5 or the back cover 51. In addition, the refrigerant pipe 200 extending toward the cabinet 11 is connected to the evaporator 24 placed in the cold air generating compartment 102 through the cabinet 11.

According to such a structure, since the separate machine room for accommodating the heat dissipation part is accommodated in a space other than the refrigerator 10, the volume of the storage compartment 101 of the refrigerator 10 may be sufficiently secured.

It will be apparent to those skilled in the art that various modifications and variations may be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A storage system for a house entrance, the storage system comprising:
an entrance refrigerator comprising:
a cabinet including:
a first surface having a first opening;
a second surface having a second opening; and
a storage space,
wherein the cabinet is configured to be embedded in an outer wall partitioning an indoor area and an outdoor area and to receive an article from the outdoor area through the first opening;
a first door configured to selectively open and close the first opening;
a second door configured to selectively open and close the second opening; and
a cold air supply assembly configured to supply cold air to the storage space; and
a first storage disposed adjacent to the entrance refrigerator and having a first storage compartment configured to store an article,
wherein the cold air supply assembly includes a heat absorption part and a heat dissipation part, and
wherein the heat dissipation part includes:
a compressor configured to compress a refrigerant;
a main condenser configured to condense the refrigerant after passing through the compressor; and
a condenser fan disposed adjacent to the main condenser, and
wherein the heat absorption part includes:
an expansion member configured to expand the refrigerant after passing through the main condenser;
an evaporator configured to evaporate the refrigerant after passing through the expansion member; and
an evaporator fan disposed adjacent to the evaporator.

2. The storage system of claim 1, further comprising a partition plate configured to partition the storage space into a storage compartment at a front of the storage space and a cold air generating compartment at a rear of the storage space,
wherein the cabinet further includes a drain hole extending through a bottom of the cold air generating compartment,
wherein the drain hole is located below the evaporator, and
wherein the bottom of the cold air generating compartment is sloped toward the drain hole.

3. The storage system of claim 1, wherein the cabinet includes a housing seating portion on a first rear outer surface of the cabinet,
wherein the storage system further comprises a housing disposed on the housing seating portion, the housing including a plurality of heat dissipation holes, and
wherein the heat dissipation part of the cold air supply assembly is positioned in the housing.

4. The storage system of claim 3, further including an auxiliary condenser connected to an outlet of the main condenser,
wherein the main condenser is provided in the housing, and
wherein the auxiliary condenser is provided at a second rear outer surface of the cabinet below the main condenser.

5. The storage system of claim 3, wherein the housing seating portion forms a step from a top surface of the cabinet, and
wherein a length of the heat dissipation portion is greater than a length of the housing seating portion.

6. The storage system of claim 1, wherein the heat dissipation part is located in the first storage compartment.

7. The storage system of claim 6, further comprising:
a machine room cover disposed within the first storage compartment and abutting against a rear wall of the first storage compartment to form a machine room in the first storage compartment, the heat dissipation part being located in the machine room, the machine room cover being provided to block air flow between the machine room and the first storage compartment; and
a back cover positioned at a rear surface of the machine room, the back cover including a plurality of holes, the plurality of holes of the back cover being configured to allow external air to flow into the machine room and air inside the machine room to be discharged to outside of the first storage.

8. The storage system of claim 1, further comprising a second storage disposed adjacent to one of the entrance refrigerator or the first storage, the second storage having a second storage compartment.

9. The storage system of claim 8, wherein each of the storage space, the first storage compartment, and the second storage compartment are configured to be maintained at different temperatures.

10. The storage system of claim 1, further comprising an auxiliary condenser connected to the main condenser in series or in parallel and mounted to an external rear surface of the cabinet,
wherein the auxiliary condenser and the main condenser are configured to operate simultaneously.

11. An entrance refrigerator, comprising:
a cabinet including:
a first surface having a first opening;
a second surface having a second opening; and
a storage space,
wherein the cabinet is configured to be embedded in an outer wall partitioning an indoor area and an outdoor area and to receive an article from the outdoor area through the first opening;
a first door configured to selectively open and close the first opening;
a second door configured to selectively open and close the second opening; and
a cold air supply assembly configured to supply cold air to the storage space, the cold air supply assembly including a heat absorption part and a heat dissipation part,
wherein the heat dissipation part includes:
a compressor configured to compress a refrigerant;
a main condenser configured to condense the refrigerant after passing through the compressor; and
a condenser fan disposed adjacent to the main condenser, and
wherein the heat absorption part includes:
an expansion member configured to expand the refrigerant after passing through the main condenser;
an evaporator configured to evaporate the refrigerant after passing through the expansion member; and
an evaporator fan disposed adjacent to the evaporator.

12. The entrance refrigerator of claim 11, further comprising a housing coupled to a housing seating portion provided at a first rear outer surface of the cabinet, the main condenser of the heat dissipation part being positioned in the housing,
wherein the housing seating portion forms a step from a top surface of the cabinet.

13. The entrance refrigerator of claim 12, wherein the housing includes a plurality of heat dissipation holes, and
wherein the plurality of heat dissipation holes are provided on surfaces excluding a bottom surface of the housing in contact with the housing seating portion and excluding a rear surface of the housing.

14. The entrance refrigerator of claim 11, further comprising a housing coupled to a housing seating portion provided at a first rear outer surface of the cabinet, the main condenser of the heat dissipation part being positioned in the housing; and
an auxiliary condenser provided at a second rear outer surface of the cabinet below the main condenser,
wherein the auxiliary condenser is connected to the main condenser.

15. The entrance refrigerator of claim 14, wherein the auxiliary condenser and the main condenser are connected in series.

16. The entrance refrigerator of claim 14, wherein the auxiliary condenser and the main condenser are connected in parallel, and
wherein the auxiliary condenser and the main condenser are configured to operate simultaneously.

17. The entrance refrigerator of claim 14, wherein the main condenser and the auxiliary condenser are branched from the outlet of the compressor and are connected in parallel, and
wherein the entrance refrigerator further includes a switching valve positioned at a point where the main condenser and the auxiliary condenser are branched.

18. The entrance refrigerator of claim 11, further comprising a partition plate configured to partition the storage space into a storage compartment at a front of the storage space and a cold air generating compartment at a rear of the storage space.

19. The entrance refrigerator of claim 18, wherein the partition plate includes:
a discharge grill at an upper end of the partition plate, wherein cold air from the cold air generating compartment enters the storage compartment through the discharge grill; and
an intake grill at a lower end of the partition plate, wherein air from the storage compartment enters the cold air generating compartment through the intake grill.

20. The entrance refrigerator of claim 18, wherein the cabinet further includes a drain hole extending through a bottom of the cold air generating compartment,
wherein the drain hole is located below the evaporator, and
wherein the bottom of the cold air generating compartment is sloped toward the drain hole.
